(19) United States
(12) Patent Application Publication
(10) Pub. No.: US 2026/0355948 A1
(43) Pub. Date: Nov. 12, 2026

(54) SCALING ROBOT DATA WITHOUT DYNAMICS SIMULATION OR ROBOT HARDWARE

(71) Applicant: Toyota Research Institute, Inc., Los Altos, CA (US)

(72) Inventors: Justin Yu, Berkeley, CA (US); Letian Fu, Berkeley, CA (US); Huang Huang, Berkeley, CA (US); Karim El-Refai, Berkeley, CA (US); Rares Andrei Ambrus, Los Altos, CA (US); Richard Cheng, Los Altos, CA (US); Muhammad Zubair Irshad, Los Altos, CA (US); Ken Goldberg, Berkeley, CA (US)

(73) Assignees: Toyota Research Institute, Inc., Los Altos, CA (US); Toyota Jidosha Kabushiki Kaisha, Toyota-shi Aichi-ken (JP); The Regents of the University of California, Oakland, CA (US)

(21) Appl. No.: 19/668,333

(22) Filed: May 5, 2026

Related U.S. Application Data
(60) Provisional application No. 63/801,291, filed on May 7, 2025.

(51) Int. Cl. B25J 9/16; G06T 7/10; G06T 15/20

(52) U.S. Cl. CPC B25J 9/163; B25J 9/1664; B25J 9/1669; G06T 7/10; G06T 15/205; G06T 2207/10016; G06T 2207/20081

(57) ABSTRACT

A method includes receiving a plurality of images of an object, receiving a video of a human manipulating the object to perform a task, reconstructing 3D object geometry and an appearance of the object based on the plurality of images, extracting 6 degree of freedom part motion of the object and its parts based on the video, synthesizing multiple object trajectories based on the 6 degree of freedom part motion, generating associated robot trajectories for a robot to perform the task, rendering videos of a plurality of robot executions of the robot manipulating the object based on the multiple object trajectories and the associated robot trajectories, and training a robot policy based on the videos of the plurality of robot executions.

### CROSS-REFERENCE TO RELATED APPLICATION

The present specification is based on, and claims the benefit of, U.S. Provisional Application No. 63/801,291, filed May 7, 2025, the disclosure of which is hereby incorporated by reference in their entirety.

### TECHNICAL FIELD

The present specification relates to generating robot training data without relying on object dynamics simulation or teleoperation of robot hardware.

### BACKGROUND

One way to train a robot to perform a particular action is via demonstration with actual robots or in a simulated environment. However, dexterous manipulation presents unique challenges, as it requires fine-grained visual perception tightly coupled with robot control and kinematics to interact with objects and alter the environment. Recent efforts have explored end-to-end generalist robot policies, including models that learn directly from raw sensory input. However, training such models at scale is limited by data, as human teleoperation datasets are quite limited. Accordingly, it may be desired to train robot learning models without requiring dynamics simulation or human teleoperation.

Prior efforts have turned to physics-based simulation, where trajectories are synthesized via reinforcement learning or motion planning in virtual environments. However, accurately modeling complex object interactions often demands extensive parameter tuning and hand-crafting of contact properties. In addition, generating high-quality, compliant, and intersection-free assets for simulation remains labor-intensive, as collision modeling requires careful handling of geometry, friction, and deformation. Accordingly, there is a need for an improved way to generate robot training data.

### SUMMARY

In one embodiment, a method includes receiving a plurality of images of an object, receiving a video of a human manipulating the object to perform a task, reconstructing 3D object geometry and an appearance of the object based on the plurality of images, extracting 6 degree of freedom part motion of the object and its parts based on the video, synthesizing multiple object trajectories based on the 6 degree of freedom part motion, generating associated robot trajectories for a robot to perform the task, rendering videos of a plurality of robot executions of the robot manipulating the object based on the multiple object trajectories and the associated robot trajectories, and training a robot policy based on the videos of the plurality of robot executions.

In another embodiment, a computing device includes one or more processors configured to receive a plurality of images of an object, receive a video of a human manipulating the object to perform a task, reconstruct 3D object geometry and an appearance of the object based on the plurality of images, extract 6 degree of freedom part motion of the object and its parts based on the video, synthesize multiple object trajectories based on the 6 degree of freedom part motion, generate associated robot trajectories for a robot to perform the task, render videos of a plurality of robot executions of the robot manipulating the object based on the multiple object trajectories and the associated robot trajectories, and train a robot policy based on the videos of the plurality of robot executions.

In another embodiment, a non-transitory computer readable storage medium stores a program. When executed by one or more processors, the program causes the one or more processors to receive a plurality of images of an object, receive a video of a human manipulating the object to perform a task, reconstruct 3D object geometry and an appearance of the object based on the plurality of images, extract 6 degree of freedom part motion of the object and its parts based on the video, synthesize multiple object trajectories based on the 6 degree of freedom part motion, generate associated robot trajectories for a robot to perform the task, render videos of a plurality of robot executions of the robot manipulating the object based on the multiple object trajectories and the associated robot trajectories, and train a robot policy based on the videos of the plurality of robot executions.

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals and in which:

FIG. 1 schematically depicts a computing device for generating robot training data, according to one or more embodiments shown and described herein;

FIG. 2A depicts an image of an example task, according to one or more embodiments shown and described herein;

FIG. 2B depicts a composite image from a video of performance of a task, according to one or more embodiments shown and described herein;

FIG. 3A depicts an example reference trajectory of an object during performance of a task, according to one or more embodiments shown and described herein;

FIG. 3B depicts example object trajectories that may be generated based on the reference trajectory of FIG. 3A, according to one or more embodiments shown and described herein; and

FIG. 4 depicts a flowchart of a method of operating the computing device of FIG. 1 to generate robot training data, according to one or more embodiments shown and described herein.

### DETAILED DESCRIPTION

The embodiments disclosed herein are directed to scaling robot data without dynamics simulation or robot hardware. In particular, embodiments disclosed herein comprise a pipeline for generating large-scale synthetic robot training data from a smartphone object scan and a human demonstration video. More particularly, a plurality of images of an object may be captured, along with a single demonstration video of a human manipulating the object to perform a task. A plurality of videos of a robot manipulating the object to perform the task may then be generated, utilizing the techniques described herein. These generated videos may then be used to train a robot policy.

In embodiments disclosed herein, trajectory diversity is scaled while preserving visual accuracy. More particularly, six degree of freedom (6-DoF) object part trajectories are extracted from the human demonstration video using weakly supervised 4D tracking, and corresponding robot executions are generated via differential inverse kinematics under randomized object initializations. Starting from a multi-view scan, 3D object geometry and appearance are reconstructed, supporting both rigid and articulated objects via part-level decomposition, and 3D Gaussian Splatting is used to produce mesh assets. The resulting trajectories include robot proprioception, end-effector actions, and paired RGB observations rendered under varied lighting, camera pose, and object placement, making them directly compatible with modern imitation learning policies such as vision-language-action models and diffusion models. By eliminating the need for dynamics simulation or robot hardware, embodiments disclosed herein enable accessible and scalable robot data collection, allowing anyone to contribute by capturing everyday object interactions with a smartphone.

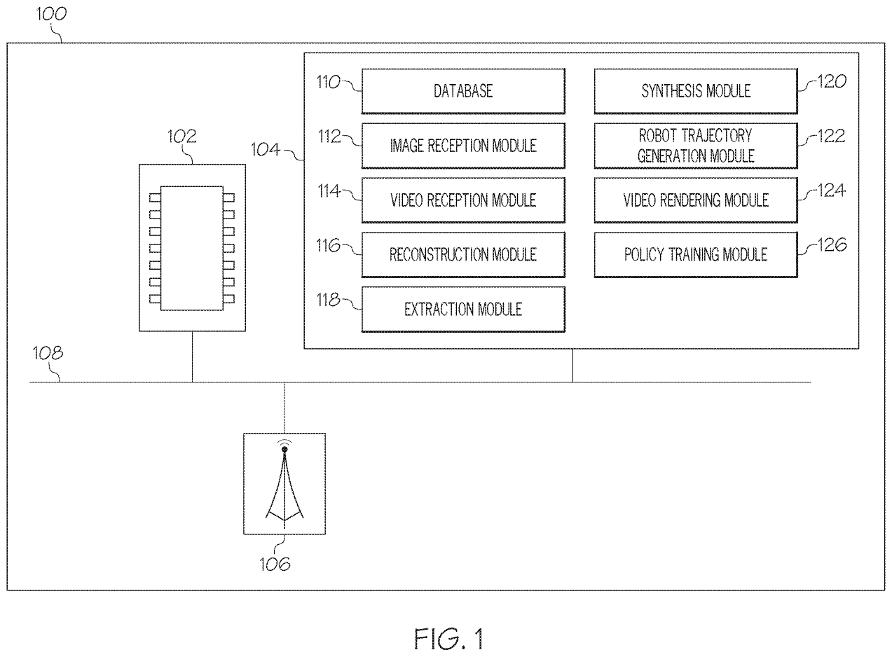

Turning now to the figures, FIG. 1 schematically depicts a computing device 100 for generating robot training data, according to the embodiments described herein. In the example of FIG. 1, the computing device 100 comprises one or more processors 102, one or more memory modules 104, network interface hardware 106, and a communication path 108. The one or more processors 102 may be a controller, an integrated circuit, a microchip, a computer, or any other computing device. The one or more memory modules 104 may comprise RAM, ROM, flash memories, hard drives, or any device capable of storing machine readable and executable instructions such that the machine readable and executable instructions can be accessed by the one or more processors 102.

The network interface hardware 106 can be communicatively coupled to the communication path 108 and can be any device capable of transmitting and/or receiving data via a network. Accordingly, the network interface hardware 106 can include a communication transceiver for sending and/or receiving any wired or wireless communication. For example, the network interface hardware 106 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 106 includes hardware configured to operate in accordance with the Bluetooth® wireless communication protocol. The network interface hardware 106 of the computing device 100 may transmit and receive data to and from a robot, or other computing devices, as disclosed herein.

The one or more memory modules 104 include a database 110, an image reception module 112, a video reception module 114, a reconstruction module 116, an extraction module 118, a synthesis module 120, a robot trajectory generation module 122, a video rendering module 124, and a policy training module 126. Each of the database 110, the image reception module 112, the video reception module 114, the reconstruction module 116, the extraction module 118, the synthesis module 120, the robot trajectory generation module 122, the video rendering module 124, and the policy training module 126 may be a program module in the form of operating systems, application program modules, and other program modules stored in the one or more memory modules 104. In some embodiments, the program module may be stored in a remote storage device that may communicate with the computing device 100. Such a program module may include, but is not limited to, routines, subroutines, programs, objects, components, data structures and the like for performing specific tasks or executing specific data types as will be described below.

The database 110 may store data used by the various memory modules 104 of the computing device 100. In particular, the database 110 may store images received by the image reception module 112, and video received by the video reception module 114. The database 110 may also store other data used by the memory modules 104.

The image reception module 112 may receive a plurality of images of an object or objects. The computing device 100 disclosed herein may be used to generate robot training data comprising videos of a robot manipulating a particular object to perform a particular task. Accordingly, a plurality of images of the object for which robot training data is desired may be received by the image reception module 112. The plurality of images of the object received by the image reception module 112 may be captured from a variety of perspectives. This may allow for a 3D object geometry and an appearance of the object to be reconstructed, as described in further detail below (e.g., using Gaussian Splatting).

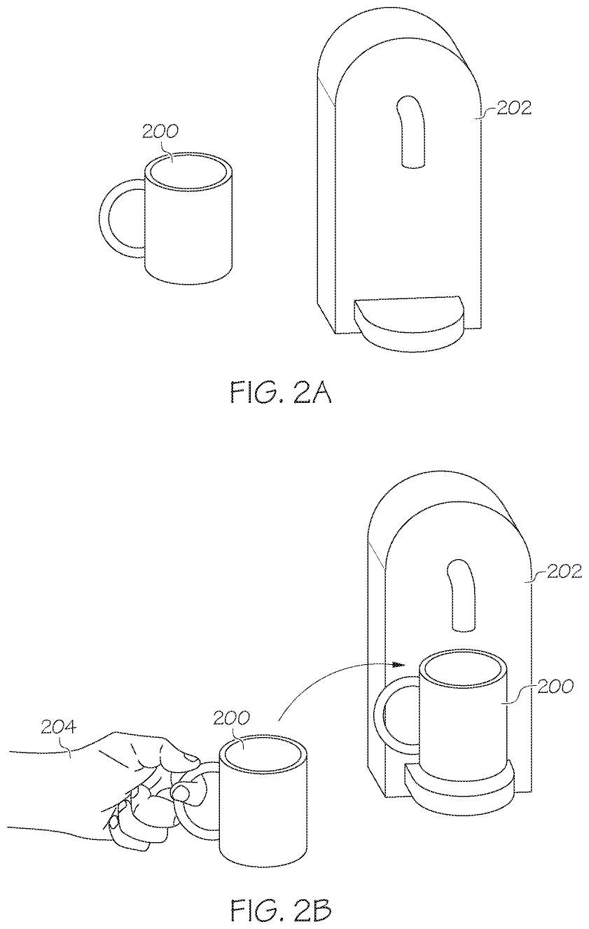

FIG. 2A shows an example image that may be received by the image reception module 112. In the example of FIG. 2A, an image includes a coffee mug 200 and a coffee maker 202. The task to be performed may comprise placing the coffee mug 200 into the coffee maker 202. In embodiments, the image reception module 112 may receive a plurality of images of the coffee mug 200 and the coffee maker 202 from a variety of perspectives.

Referring back to FIG. 1, the video reception module 114 may receive a video of a human manipulating the object to perform a task. In particular, the video reception module 114 may receive a video of a human manipulating the object to perform a task for which robot training data is desired. In embodiments, the video reception module 114 may receive a single video of a human manipulating the object to perform the specified task. This video may be used to extract 6 degree of freedom part motion of the object, as disclosed in further detail below.

FIG. 2B depicts an example composite image of a video that may be received by the video reception module 114. In the example of FIG. 2B, a video may depict a hand of a human 204 moving the coffee mug 200 into the coffee maker 202. While FIG. 2B depicts a composite still image for purposes of illustration, it should be understood that the video reception module 114 may receive a video of the entire motion of the human 204 placing the coffee mug 200 into the coffee maker 202.

Referring back to FIG. 1, the reconstruction module 116 may reconstruct 3D object geometry and an appearance of the object in the images received by the image reception module 112, as disclosed herein. In order to generate robot training data based on the images received by the image reception module 112 and the demonstration video received by the video reception module 114, the computing device 100 first performs asset and trajectory extraction, where rigid or articulated object geometry and part trajectories are extracted from the received data. In embodiments disclosed herein, asset extraction may be performed by the reconstruction module 116, and trajectory extraction may be performed by the extraction module 118, as disclosed in further detail below.

In embodiments, the reconstruction module 116 may extract 3D object assets from the images received by the image reception module 112. In the illustrated example, this may be performed in a two-stage process. In a first stage, the reconstruction module 116 reconstructs object geometry and appearance using 3D Gaussian Splatting (3DGS). In a second stage, the reconstruction module 116 segments a scene into semantically meaningful parts by lifting 2D masks into 3D. This enables both object-level and part-level decomposition, including articulated components. In one example, the reconstruction module 116 utilizes the Group Anything with Radiance Fields (GARField) technique to segment the scene. In some examples, in order to support mesh-based rendering, the Gaussian groups resulting from the Gaussian Splatting are converted into textured triangle meshes.

Referring still to FIG. 1, the extraction module 118 may extract 6 degree of freedom (6-DoF) part motion of the object in the image received by the image reception module 112, and its parts, based on the video received by the video reception module 114, as disclosed herein. In one example, the extraction module 118 may extract the 6-DoF part motion of the object using 4D Differentiable Part Modeling (4D-DPM). In embodiments, each 3DGS object may be embedded with pre-trained DINO features, enabling part pose optimization through differentiable rendering. This may allow for tracking of single or multiple rigid objects, as well as articulated objects, from demonstration videos received by the video reception module 114. A 3DGS to mesh conversion enables background-foreground segmentation and part decomposition via 3D grouping, which allows for extracting object part-specific trajectories from monocular human demonstrations. It also maintains compatibility with both 4D-DPM trajectory reconstruction and mesh-based rendering engines, allowing seamless integration into the disclosed large-scale rendering pipeline. This process does not require any fiducials or hardware beyond a smartphone camera, making it well-suited for scalable and accessible data generation.

Referring still to FIG. 1, the synthesis module 120 may synthesize multiple object trajectories based on the 6-DoF part motion extracted by the extraction module 118, as disclosed herein. In particular, the synthesis module 120 may synthesize multiple valid 6-DoF object trajectories from a single human demonstration. In the case of multiple rigid objects that interact (e.g., putting a mug on a coffee maker, as shown in FIGS. 2A and 2B), the original demonstration video may only be valid for a specific initial object configuration, and naively replaying it from a new initial pose may fail. Accordingly, in embodiments disclosed herein, trajectory interpolation and resampling techniques are disclosed that adapt the original trajectory to new start and end poses while preserving semantic intent.

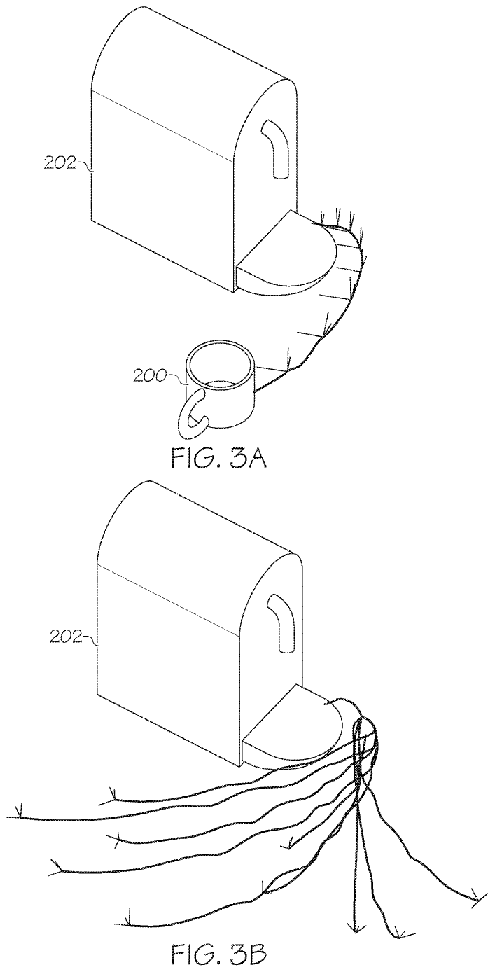

An initial reference trajectory τ∈^{T×7} waypoints provided by the part tracking from the demonstration video received by the video reception module 114. Given a new initial pose xₛₜₐᵣₜ and a desired end pose x_{end} from human demonstration, the synthesis module 120 applies a spatial normalization that transforms the original trajectory into a canonical space. The synthesis module 120 computes an affine transform between the original and target endpoints poses, applies it to the translational component of the trajectory, and interpolates keyframe orientations using spherical linear interpolation (Slerp). This results in a new trajectory τ′ that begins and ends at the desired poses while respecting the structure of the original motion. While these trajectories preserve high-level semantic intent, they are generated without explicit collision avoidance and may result in infeasible paths when initialized behind occluding objects. To mitigate this, the synthesis module 120 may apply a sampling heuristic that biases the distribution of initial placements away from the goal pose. FIG. 3A shows a reference trajectory moving the coffee mug 200 to the coffee maker that may be demonstrated in a video received by the video reception module 114. FIG. 3B shows a plurality of object trajectories that may be synthesized by the synthesis module 120, which each have a different starting position.

Referring back to FIG. 1, the robot trajectory generation module 122 may generate robot trajectories associated with the object trajectories synthesized by the synthesis module 120 for a robot to perform the task demonstrated in the video received by the video reception module 114, as disclosed herein. While the object trajectories indicate a trajectory of an object during the performance of a task, robot trajectories indicate joint angles and end effector positions for a robot to perform the task.

In embodiments, the robot trajectory generation module 122 may estimate 3D hand keypoints from the demonstration video received by the video reception module 114. The robot trajectory generation module 122 may then determine object-hand interactions by computing the Euclidean distance between keypoints (e.g., index fingertip and thumb) and the centroids of all segmented object parts. This produces a distance matrix indexed over time and object parts. The robot trajectory generation module 122 may identify the grasped part of the object as the part with a minimum aggregate distance across the trajectory, effectively selecting the object most consistently proximal to the hand throughout the demonstration.

To generate physically plausible grasps for a robot, the robot trajectory generation module 122 may sample 3DGS means to construct a coarser triangle mesh (distinct from the high-resolution rendering mesh), apply surface smoothing and decimation to obtain consistent normals, and use an analytic antipodal grasp sampler to determine candidate grasp axes. For bimanual tasks, the robot trajectory generation module 122 may apply this process independently per hand to infer separate object associates and grasps, to support coordinated actions such as lifting or stabilization.

After determining candidate grasp axes, for each grasp and object trajectory pair, the robot trajectory generation module 122 may solve a differential inverse kinematics problem. In particular, the robot trajectory generation module 122 may compute smooth joint-space trajectories that induce desired object motion across pre-grasp, grasp, and post-grasp phases. The disclosed method does not require modeling object dynamics or simulating physics interactions. Rather, instead of solving for joint torques that would physically induce object movement (as in a dynamic simulation), it is assumed that the object rigidly follows the trajectory during contact. This kinematic assumption avoids challenges like contact modeling, compliance, or friction estimation. Rather, the robot trajectory generation module 122 simply ensures that robot kinematics can track the desired object motion subject to joint position limits, and during pre-and post-grasp phases, smoothness and velocity limits constraints can also be included, which generates valid grasp approach motions.

Referring still to FIG. 1, the video rendering module 124 may render videos of a plurality of robot executions of the robot manipulating the object based on the object trajectories determined by the synthesis module 120 and the robot trajectories determined by the robot trajectory generation module 122. These videos may then be used to train a robot policy, as discussed in further detail below.

In embodiments, the video rendering module 124 may apply domain randomization across both scene geometry and rendering parameters. This may increase the number of videos of robot executions of the robot manipulating the object that may be used to train the robot policy, thereby improving robustness of the resulting robot policy. In embodiments, the video rendering module 124 may randomize a variety of parameters including lighting conditions (e.g., intensity, color temperature), camera extrinsics (e.g., uniformly sampled up to 2 cm translation and 5° rotation), and object initial poses (e.g., sampled within a workspace-relevant range). By modeling 3D object-centric representations, the video rendering module 124 may apply these augmentations directly during rendering. Changes in camera pose or lighting do not affect the underlying kinematic rollout, allowing the disclosed embodiments to generate diverse visual contexts from a single demonstration. These augmentations may expand the data distribution and improve generalization by mitigating the appearance gap and covariate shift between synthetic demonstrations and real-world deployment. In some examples, the video rendering module 124 utilizes parallel execution of multiple environment contexts using tile-based rendering, deep-learning super sampling (DLSS), and mesh asset instancing (e.g., using IsaacLab).

Referring still to FIG. 1, the policy training module 126 may train a robot policy based on the videos of the plurality of robot executions generated by the video rendering module 124. In particular, the policy training module 126 may train a robot policy to cause a robot to perform the task demonstrated in the video received by the video reception module 114. The policy training module 126 may utilize an imitation learning architecture to train the robot policy. In embodiments, a robot is operated to perform a task with the trained robot policy.

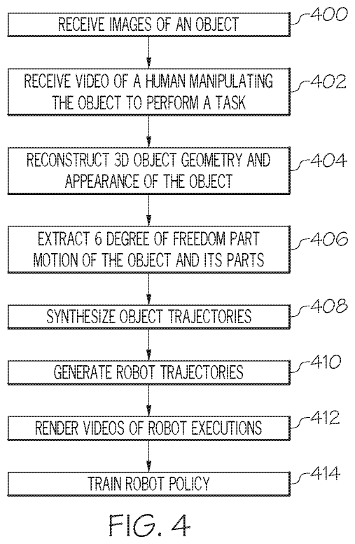

Turning now to FIG. 4 (in conjunction with FIG. 1), a flowchart of an example method for operating the computing device 100 to generate robot training data is depicted. At step 400, the image reception module 112 receives a plurality of images of an object. In particular, the image reception module 112 receives a plurality of images of an object to be manipulated to perform a task. The image reception module 112 may receive images of the object from a variety of different perspectives.

At step 402, the video reception module 114 receives video of a human manipulating the object in the images received by the image reception module 112 to perform a task. In particular, the video reception module 114 may receive a video of a human performing a task, involving manipulation of the object, for which object robot training data is desired. The robot training data may comprise video of a robot manipulating the object to perform the task, as discussed above.

At step 404, the reconstruction module 116 reconstructs 3D object geometry and appearance of the object in the images received by the image reception module 112. As discussed above, the reconstruction module 116 may reconstruct the 3D object geometry and the appearance of the object using 3D Gaussian Splatting. More particularly, the reconstruction module 116 may convert Gaussian groups associated with the 3D Gaussian Splatting into textured triangle meshes.

At step 406, the extraction module 118 extracts 6 degree of freedom part motion of the object and its parts. More particularly, the extraction module 118 may segment the object into a plurality of 2D masks representing a plurality of portions of the object, and lift the plurality of 2D masks into 3D. The extraction module 118 may extract the 6 degree of freedom part motion of the object and its parts using 4D Differentiable Part Modeling. The extraction module 118 may embed the parts of the object with pre-trained DINO features.

At step 408, the synthesis module 120 synthesizes multiple object trajectories based on the 6 degree of freedom part motion extracted by the extraction module 118. As discussed above, this may allow for multiple object trajectories to be generated from a single human demonstration.

At step 410, the robot trajectory generation module 122 generates robot trajectories associated with the object trajectories synthesized by the synthesis module 120. As discussed above, the robot trajectories may comprise robot actions to cause the robot to manipulate the object to follow the synthesized object trajectories. In particular, the robot trajectory generation module 122 may determine a plurality of candidate grasps for the robot to grasp the object, and select a grasp among the plurality of candidate grasps by solving a differential inverse kinematics problem.

At step 412, the video rendering module 124 renders videos of robot executions of the robot manipulating the object to perform the task based on the multiple object trajectories synthesized by the synthesis module 120 and the robot trajectories generated by the robot trajectory generation module 122. The rendered videos may apply domain randomization across scene geometry and rendering parameters to generate additional videos of robot executions of performance of the task.

At step 414, the policy training module 126 trains a robot policy based on the videos of the plurality of robot executions of the task performance rendered by the video rendering module 124. The robot policy may cause a robot to manipulate the object to perform the task. As discussed above, the policy training module 126 may train the robot policy using imitation learning.

It should now be understood that embodiments described herein are directed to generating robot training data without relying on object dynamics simulation or teleoperation of robot hardware. Using the techniques of this disclosure, robot training data, comprising videos of a robot performing a task, may be generated simply by receiving images of an object to be manipulated during the task and a single demonstration video of a human performing a specified task. This may allow for scaling robot data without dynamics simulation or robot hardware, thereby allowing for the training of a robot policy.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving a plurality of images of an object;
receiving a video of a human manipulating the object to perform a task;
reconstructing 3D object geometry and an appearance of the object based on the plurality of images;
extracting 6 degree of freedom part motion of the object and its parts based on the video;
synthesizing multiple object trajectories based on the 6 degree of freedom part motion;
generating associated robot trajectories for a robot to perform the task;
rendering videos of a plurality of robot executions of the robot manipulating the object based on the multiple object trajectories and the associated robot trajectories; and
training a robot policy based on the videos of the plurality of robot executions.

2. The method of claim 1, further comprising reconstructing the 3D object geometry and the appearance of the object using 3D Gaussian Splatting.

3. The method of claim 2, further comprising converting Gaussian groups associated with the 3D Gaussian Splatting into textured triangle meshes.

4. The method of claim 1, further comprising:
segmenting the object into a plurality of 2D masks representing a plurality of portions of the object; and
lifting the plurality of 2D masks into 3D.

5. The method of claim 1, further comprising extracting 6 degree of freedom part motion of the object and parts of the object using 4D Differentiable Part Modeling.

6. The method of claim 5, further comprising embedding the parts of the object with pre-trained DINO features.

7. The method of claim 1, wherein generating the associated robot trajectories comprises:
determining a plurality of candidate grasps for the robot to grasp the object; and
selecting a grasp among the plurality of candidate grasps by solving a differential inverse kinematics problem.

8. The method of claim 1, wherein rendering the videos of the plurality of robot executions of the robot manipulating the object comprises applying domain randomization across scene geometry and rendering parameters.

9. The method of claim 1, further comprising training the robot policy using imitation learning.

10. A computing device comprising one or more processors configured to:
receive a plurality of images of an object;
receive a video of a human manipulating the object to perform a task;
reconstruct 3D object geometry and an appearance of the object based on the plurality of images;
extract 6 degree of freedom part motion of the object and its parts based on the video;
synthesize multiple object trajectories based on the 6 degree of freedom part motion;
generate associated robot trajectories for a robot to perform the task;
render videos of a plurality of robot executions of the robot manipulating the object based on the multiple object trajectories and the associated robot trajectories; and
train a robot policy based on the videos of the plurality of robot executions.

11. The computing device of claim 10, wherein the one or more processors are further configured to reconstruct the 3D object geometry and the appearance of the object using 3D Gaussian Splatting.

12. The computing device of claim 11, wherein the one or more processors are further configured to convert Gaussian groups associated with the 3D Gaussian Splatting into textured triangle meshes.

13. The computing device of claim 10, wherein the one or more processors are further configured to:
segment the object into a plurality of 2D masks representing a plurality of portions of the object; and
lift the plurality of 2D masks into 3D.

14. The computing device of claim 10, wherein the one or more processors are further configured to extract 6 degree of freedom part motion of the object and parts of the object using 4D Differentiable Part Modeling.

15. The computing device of claim 14, wherein the one or more processors are further configured to embed the parts of the object with pre-trained DINO features.

16. The computing device of claim 10, wherein the one or more processors are configured to generate the associated robot trajectories by:
determining a plurality of candidate grasps for the robot to grasp the object; and
and selecting a grasp among the plurality of candidate grasps by solving a differential inverse kinematics problem.

17. The computing device of claim 10, wherein the one or more processors are configured to render the videos of the plurality of robot executions of the robot manipulating the object by applying domain randomization across scene geometry and rendering parameters.

18. The computing device of claim 10, wherein the one or more processors are further configured to train the robot policy using imitation learning.

19. A non-transitory computer readable storage medium storing a program that when executed by one or more processors, causes the one or more processors to:
receive a plurality of images of an object;
receive a video of a human manipulating the object to perform a task;
reconstruct 3D object geometry and an appearance of the object based on the plurality of images;
extract 6 degree of freedom part motion of the object and its parts based on the video;
synthesize multiple object trajectories based on the 6 degree of freedom part motion;
generate associated robot trajectories for a robot to perform the task;
render videos of a plurality of robot executions of the robot manipulating the object based on the multiple object trajectories and the associated robot trajectories; and
train a robot policy based on the videos of the plurality of robot executions.

20. The non-transitory computer readable storage medium of claim 19, wherein the program cause the one or more processors to reconstruct the 3D object geometry and the appearance of the object using 3D Gaussian Splatting.
